(19) United States
(12) Patent Application Publication
(10) Pub. No.: US 2014/0379163 A1
(43) Pub. Date: Dec. 25, 2014

(54) CONTROLLER AND METHOD FOR CONTROLLING FAN AND ELECTRONIC DEVICE USING THE SAME

(71) Applicant: HON HAI PRECISION INDUSTRY CO. LTD., New Taipei (TW)

(72) Inventor: CHAO-KE WEI, New Taipei (TW)

(21) Appl. No.: 14/314,232

(22) Filed: Jun. 25, 2014

(30) Foreign Application Priority Data
Jun. 25, 2013 (TW) 102122603

(51) Int. Cl. G05D 23/19; G05D 13/62

(52) U.S. Cl. CPC G05D 23/19; G05D 13/62
USPC 700/300

(57) ABSTRACT

A method for controlling a speed of a fan of an electronic device is provided. The method includes determining whether the electronic device is overheated or overcooled when the fan is in a real-time working status of uniform speed. The fan is controlled to accelerate when the electronic device is overheated, or decelerate when the electronic device is overcooled. A controller and an electronic device using the same are also provided.

### FIELD

This application is related to heat dissipation technology, especially to a controller and method for controlling a fan for heat dissipation, and an electronic device using the same.

### BACKGROUND

With the development of science and technology, there are more and more electronic products that require heat dissipation.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of an electronic device.

FIG. 2 is a flowchart of a method for controlling a speed of a fan applied in an electronic device, such as the electronic device shown in FIG. 1, when a reference temperature value is null.

FIGS. 3 and 4 cooperatively constitute a flowchart of a method for controlling a speed of a fan applied in an electronic device, such as the electronic device shown in FIG. 1, when the reference temperature value is not null.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

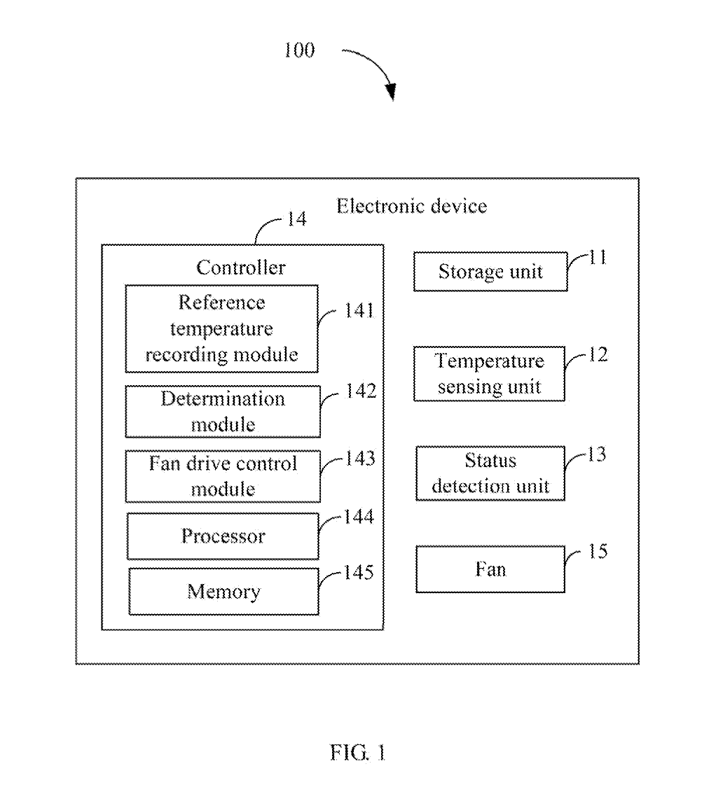

FIG. 1 illustrates a block diagram of an embodiment of an electronic device 100. The electronic device 100 can include a storage unit 11, a temperature sensing unit 12, a status detection unit 13, a controller 14, and a fan 15. The controller 14 can control a rotation speed of the fan 15. In the embodiment, the fan 15 can be a rotary fan. In other embodiments, the fan 15 can be any other type of fan.

The storage unit 11 stores a first preset temperature value and a second preset temperature value. In the embodiment, the second preset temperature value is less than the first preset temperature value.

The temperature sensing unit 12 senses a real-time temperature value of the electronic device 100. When the real-time temperature value is between the first preset temperature value and the second preset temperature value, the electronic device 100 is in a normal state that is not overheated or overcooled. When the real-time temperature value is greater than the first preset temperature value, the electronic device 100 is overheated. When the real-time temperature value is less than the second preset temperature value, the electronic device 100 is overcooled.

The status detection unit 13 detects a real-time working status of the fan 15. The real-time working status of the fan 15 can be a status of acceleration, a status of deceleration, or a status of uniform speed.

In the embodiment, the controller 14 can control the fan 15 to accelerate, decelerate, or maintain a uniform speed.

The fan 15 can dissipate heat generated by the electronic device 100.

The controller 14 can include a reference temperature recording module 141, a determination module 142, and a fan drive control module 143. The controller 14 can also include a processor 144 and memory 145 coupled to the processor 144 and used to store instructions corresponding to the reference temperature recording module 141, the determination module 142, and the fan drive control module 143 and the reference temperature recording module 141, the determination module 142, and the fan drive control module 143 both have instruction cause the processor 144 to do something, and the details are following.

The reference temperature recording module 141 records a reference temperature value. In detail, after each acceleration or deceleration of the fan 15, the reference temperature recording module 141 sets the real-time temperature value of the electronic device 100 as the reference temperature value when the real-time temperature value is outside a range between the first preset temperature value and the second preset temperature value. In this embodiment, the reference temperature value is null before the fan 15 accelerates or decelerates for a first time, and after each acceleration or deceleration of the fan 15, the reference temperature value is set as null when the real-time temperature value of the electronic device 100 is between the first preset temperature value and the second preset temperature value.

Because the temperature of the electronic device 100 takes time to increase or decrease after the fan 15 accelerates or decelerates, the reference temperature value is recorded to determine whether the rotation speed of the fan 15 is enough to cool the electronic device 100. For example, when the real-time temperature value of the electronic device 100 is greater than the first preset temperature value, but less than the reference temperature value, the rotation speed of the fan 15 is adequate and another acceleration of the fan 15 is not required. Similarly, when the real-time temperature value of the electronic device 100 is less than the second preset temperature value, but greater than the reference temperature value, the rotation speed of the fan 15 is adequate and another deceleration of the fan 15 is not required. When the real-time temperature value of the electronic device 100 is greater than both the first preset temperature value and the reference temperature value, the rotation speed of the fan 15 is not adequate and another acceleration of the fan 15 is required. Similarly, when the real-time temperature value of the electronic device 100 is less than both the second preset temperature value and the reference temperature value, the rotation speed of the fan 15 is not adequate and another deceleration of the fan 15 is required.

The determination module 142 obtains both the real-time temperature value of the electronic device 100 sensed by the temperature sensing unit 12 and the real-time working status of the fan 15 detected by the status detection unit 13 at predetermined time intervals. When the fan 15 is in the real-time working status of uniform speed, the determination module 142 compares the real-time temperature value with the first preset temperature value, the second preset temperature value, and the reference temperature value.

When the reference temperature value is null while the real-time temperature value is greater than the first preset temperature value, the determination module 142 determines that the electronic device 100 is overheated and generates an acceleration signal. Similarly, when the reference temperature value is null while the real-time temperature value is less than the second preset temperature value, the determination module 142 determines that the electronic device 100 is overcooled and generates a deceleration signal.

When the reference temperature value is not null, the determination module 142 determines that the electronic device 100 is overheated and generates the acceleration signal when the real-time temperature value is greater than both the first preset temperature value and the reference temperature value. Similarly, the determination module 142 determines that the electronic device 100 is overcooled and generates the deceleration signal when the real-time temperature value is less than both the second preset temperature value and the reference temperature value.

The fan drive control module 143 controls the fan 15 to accelerate according to the acceleration signal, or decelerate according to the deceleration signal.

After the reference temperature value is recorded, the determination module 142 further generates an empty signal when the real-time temperature value of the electronic device 100 is between the first preset temperature value and the second preset temperature value.

The reference temperature recording module 141 sets the reference temperature value to null according to the empty signal generated by the determination module 142.

In one embodiment, the temperature sensing unit 12 can include a number of temperature sensors for sensing the real-time temperature values of corresponding parts of the electronic device 100.

FIG. 1 only shows one fan 15. In other embodiments, the electronic device 100 can include a number of fans 15. Each fan 15 can correspond to one temperature sensor. Thus, when the determination module 142 determines that the part of the electronic device 100 corresponding to one temperature sensor is overheated or overcooled according to the sensed real-time temperature of the corresponding temperature sensor, the fan drive control module 143 can control the corresponding fan 15 to accelerate or decelerate accordingly.

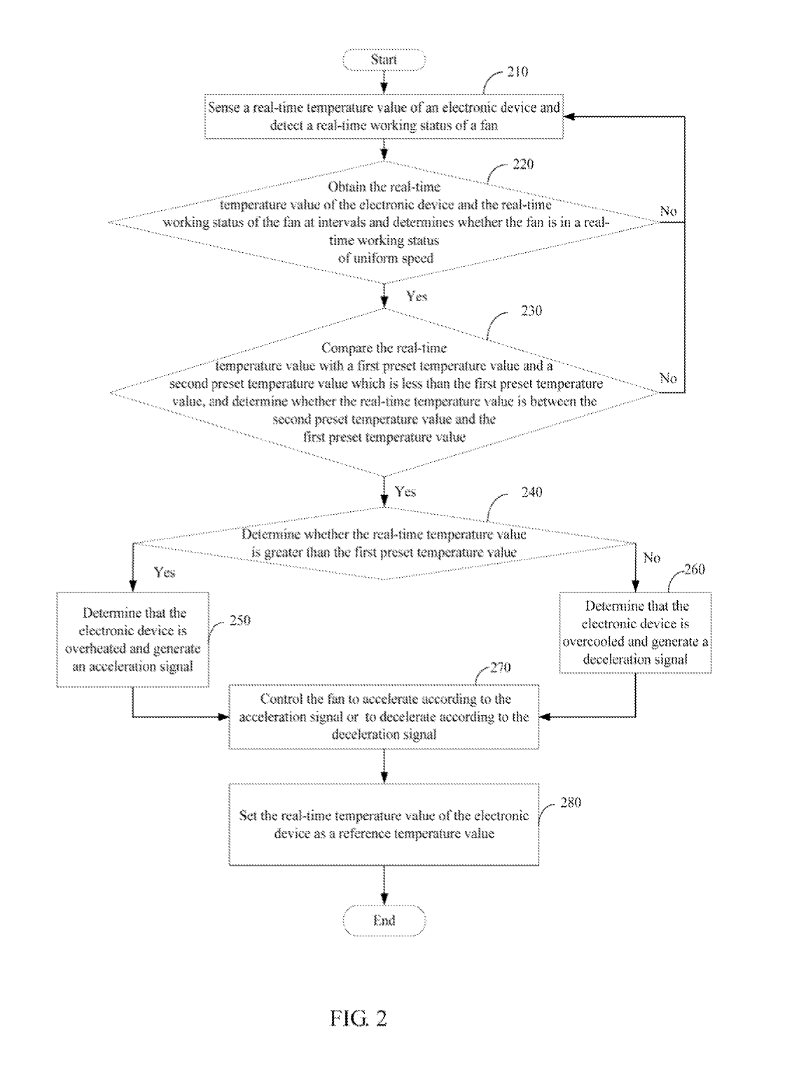

FIG. 2 illustrates a flowchart of a method for controlling a speed of a fan applied in an electronic device, such as the one shown in FIG. 1, when a reference temperature is null. The electronic device can include a temperature sensing unit, a status detection unit, a determination module, a fan drive control module, a reference temperature recording module, and a fan for properly dissipating heat generated by the electronic device.

In block 210, the temperature sensing unit senses a real-time temperature value of the electronic device, and the status detection unit detects a real-time working status of the fan.

In block 220, the determination module obtains both the real-time temperature value of the electronic device sensed by the temperature sensing unit and the real-time working status of the fan detected by the status detection unit at intervals, and determines whether the fan is in the real-time working status of uniform speed. If the fan is in the real-time working status of uniform speed, block 230 is implemented. Otherwise, block 210 is implemented.

In block 230, the determination module compares the real-time temperature value with a first preset temperature value and a second preset temperature value, wherein the second preset temperature value is less than the first preset temperature value, and determines whether the real-time temperature value is between the first preset temperature value and the second preset temperature value. If the real-time temperature value is between the first preset temperature value and the second preset temperature value, block 210 is implemented. Otherwise, block 240 is implemented.

In block 240, the determination module determines whether the real-time temperature value is greater than the first preset temperature value. If the real-time temperature value is greater than the first preset temperature value, block 250 is implemented. Otherwise, block 260 is implemented.

In block 250, the determination module determines that the electronic device 100 is overheated and generates an acceleration signal, and then block 270 is implemented.

In block 260, the determination module determines that the electronic device 100 is overcooled and generates a deceleration signal, and then block 270 is implemented.

In block 270, the fan drive control module controls the fan to accelerate according to the acceleration signal, or decelerate according to the deceleration signal.

In block 280, the reference temperature recording module sets the real-time temperature value of the electronic device as the reference temperature value.

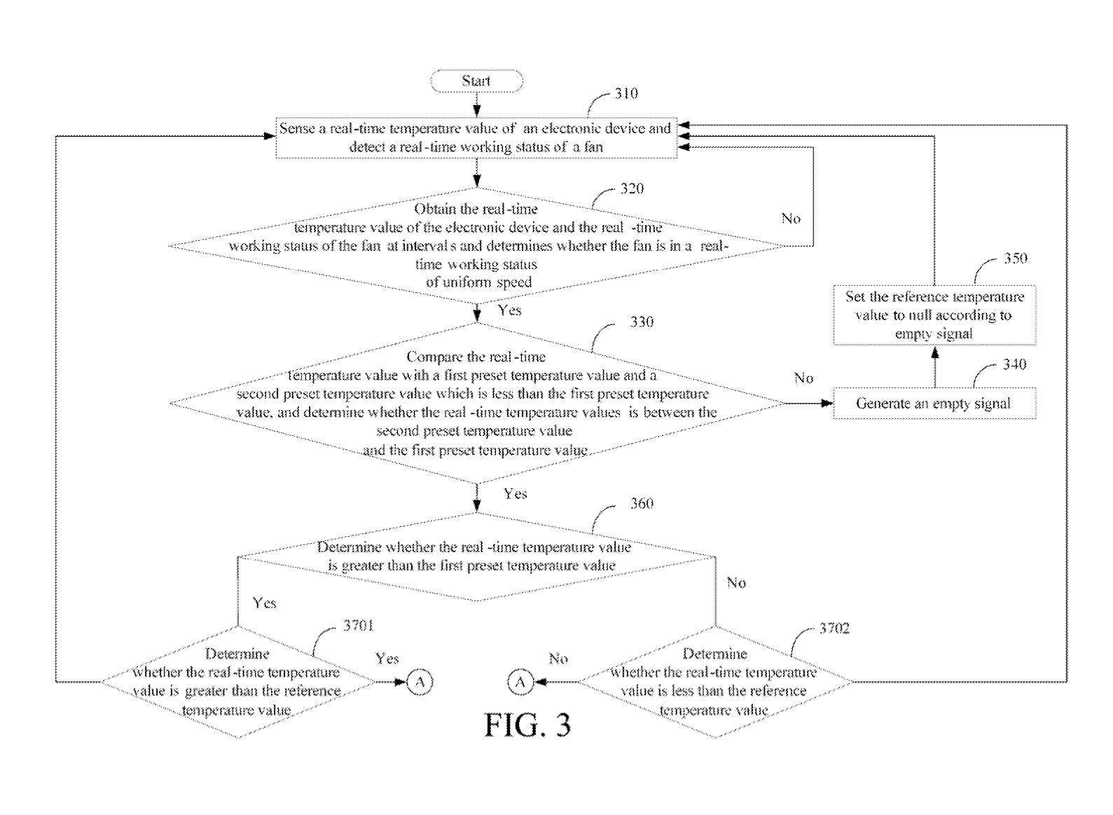

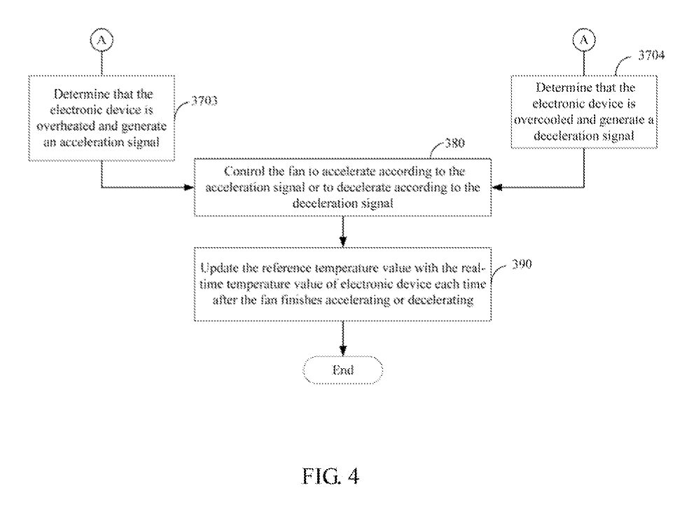

FIGS. 3 and 4 cooperatively constitute a flowchart of a method for controlling a speed of a fan applied in an electronic device, such as the one shown in FIG. 1, when a reference temperature value is not null. The electronic device can include a temperature sensing unit, a status detection unit, a determination module, a fan drive control module, a reference temperature recording module, and a fan for properly dissipating heat generated by the electronic device.

In block 310, the temperature sensing unit senses a real-time temperature value of the electronic device, and the status detection unit detects a real-time working status of the fan.

In block 320, the determination module obtains both the real-time temperature value of the electronic device sensed by the temperature sensing unit and the real-time working status of the fan detected by the status detection unit at intervals, and determines whether the fan is in the real-time working status of uniform speed. If the fan is in the real-time working status of uniform speed, block 330 is implemented. Otherwise, block 310 is implemented.

In block 330, the determination module compares the real-time temperature value with a first preset temperature value and a second preset temperature value, wherein the second preset temperature value is less than the first preset temperature value, and determines whether the real-time temperature value is between the first preset temperature value and the second preset temperature value. If the real-time temperature value is between the first preset temperature value and the second preset temperature value, block 340 is implemented. Otherwise, block 360 is implemented.

In block 340, the determination module generates an empty signal.

In block 350, the reference temperature recording module sets the reference temperature value to null according to empty signal, and then block 310 is implemented.

In block 360, the determination module determines whether the real-time temperature value is greater than the first preset temperature value. If the real-time temperature value is greater than the first preset temperature value, block 3701 is implemented. Otherwise, block 3702 is implemented.

In block 3701, the determination module determines whether the real-time temperature value is greater than the reference temperature value. If the real-time temperature value is greater than the reference temperature value, block 3703 is implemented. Otherwise, block 310 is implemented.

In block 3702, the determination module determines whether the real-time temperature value is less than the reference temperature value. If the real-time temperature value is less than the reference temperature value, block 3704 is implemented. Otherwise, block 310 is implemented.

In block 3703, the determination module determines that the electronic device is overheated and generates an acceleration signal, and then block 380 is implemented.

In block 3704, the determination module determines that the electronic device is overcooled and generates a deceleration signal, and then block 380 is implemented.

In block 380, the fan drive control module controls the fan to accelerate according to the acceleration signal, or decelerate according to the deceleration signal.

In block 390, the reference temperature recording module updates the reference temperature value with the real-time temperature value of the electronic device after the fan finishes accelerating or decelerating.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A controller configured to control a rotational speed of a fan coupled to an electronic device, the controller comprising:
a processor;
a memory coupled to the processor and configured to store instructions corresponding to:
a determining module having instructions to cause the processor to determine, while the fan is operated at a uniform speed, whether the electronic device is overheated or overcooled; and
a fan drive control module having instructions to cause the processor to control the fan to accelerate when the electronic device is overheated and to decelerate when the electronic device is overcooled.

2. The controller as described in claim 1, wherein the determining module having instructions to cause the processor to obtain a real-time temperature value of the electronic device and further compare the real-time temperature value with a first preset temperature value, a second preset temperature value, and a reference temperature value, wherein the second preset temperature value is less than the second preset temperature value, while the fan is operated at a uniform speed, and
determine that the electronic device is overheated when the real-time temperature value is greater than the first preset temperature value when the reference temperature value is null; and
determine that the electronic device is overcooled when the real-time temperature value is less than the second preset temperature value when the reference temperature value is null.

3. The controller as described in claim 2, wherein the determining module having instructions to cause the processor to determine that the electronic device is overheated when the real-time temperature value is greater than both the second preset temperature value and the reference temperature when the reference temperature value is not null; and
determine that the electronic device is overcooled when the real-time temperature value is less than both the second preset temperature value and the reference temperature value when the reference temperature value is not null.

4. The controller as described in claim 3, wherein the controller further comprises:
a reference temperature recording module having instructions to cause the processor to update the reference temperature value with the real-time temperature value of the electronic device of when after the fan finishes accelerating or decelerating when the real-time temperature value is outside a range between the first preset temperature value and the second preset temperature value.

5. The controller as described by claim 4, wherein the reference temperature value is null before the fan finishes accelerating or decelerating for a first time.

6. The controller as described by claim 5, wherein the reference temperature value is set as null by the reference temperature recording module when the real-time temperature value of the electronic device is between the first preset temperature value and the second preset temperature value after the fan finishes accelerating or decelerating for the first time.

7. An electronic device comprising:
a fan equipping on the electronic device to properly dissipate heat generated by the electronic device;
a controller controlling a rotation speed of the fan;
a storage unit storing a first preset temperature value and a second preset temperature value wherein the second preset temperature value is less than the first preset temperature value; and
a temperature sensing unit sensing a real-time temperature value of the electronic device;
wherein the controller further comprises:
a processor;
a memory coupled to the processor and configured to store instructions corresponding to:
a determining module having instructions to cause the processor to determine, while the fan is operated at a uniform speed, whether the electronic device is overheated or overcooled; and
a fan drive control module having instructions to cause the processor to control the fan to accelerate when the electronic device is overheated and to decelerate when the electronic device is overcooled.

8. The electronic device as described in claim 6, wherein the determining module having instructions to cause the processor to obtain a real-time temperature value of the electronic device and further compare the real-time temperature value with the first preset temperature value, the second preset temperature value, and a reference temperature value, wherein the second preset temperature value is less than the second preset temperature value, while the fan is operated at a uniform speed,;
determine that the electronic device is overheated when the real-time temperature value is greater than the first preset temperature value when the reference temperature value is null; and
determine that the electronic device is overcooled when the real-time temperature value is less than the second preset temperature value when the reference temperature value is null.

9. The controller as described in claim 8, wherein the determining module having instructions to cause the processor to determine that the electronic device is overheated when the real-time temperature value is greater than both the second preset temperature value and the reference temperature when the reference temperature value is not null; and
determine that the electronic device is overcooled when the real-time temperature value is less than both the second preset temperature value and the reference temperature value when the reference temperature value is not null.

10. The electronic device as described in claim 9, wherein the controller further comprises a reference temperature recording module having instructions to cause the processor to update the reference temperature value with the real-time temperature value of the electronic device of when after the fan finishes accelerating or decelerating when the real-time temperature value is outside a range between the first preset temperature value and the second preset temperature value.

11. The electronic device as described in claim 10, wherein the reference temperature value is null before the fan finishes accelerating or decelerating for a first time.

12. The electronic device as described in claim 11, wherein the reference temperature value is set as null by the reference temperature recording module when the real-time temperature value of the electronic device is between the first preset temperature value and the second preset temperature value after the fan finishes accelerating or decelerating for the first time.

13. A method for fan controlling comprising:
determining whether the electronic device is overheated or overcooled when the fan is in uniform speed status; and
controlling the fan to accelerate when the electronic device is overheated or to decelerate when the electronic device is overcooled.

14. The method as described in claim 13, wherein determining whether the electronic device is overheated or overcooled when the fan is in uniform speed status further comprises:
obtaining a real-time temperature value of an electronic device;
comprising the real-time temperature value with a first preset temperature value, a second preset temperature value, and a reference temperature value, wherein the second preset temperature value is less than the second preset temperature value, when the fan is operated at a uniform speed;
determining that the electronic device is overheated when the real-time temperature value is greater than the first preset temperature value when the reference temperature value is null; and
determining that the electronic device is overcooled when the real-time temperature value is less than the second preset temperature value when the reference temperature value is null.

15. The method as described in claim 14, wherein determining whether the electronic device is overheated or overcooled when the fan is in uniform speed status further comprises:
determining that the electronic device is overheated when the real-time temperature value is greater than both the second preset temperature value and the reference temperature when the reference temperature value is not null; and
determining that the electronic device is overcooled when the real-time temperature value is less than both the second preset temperature value and the reference temperature value when the reference temperature value is not null.

16. The method as described in claim 15, further comprising:
after the fan finishes accelerating or decelerating, updating the reference temperature value with the real-time temperature value of the electronic device when the real-time temperature value is outside a range between the first preset temperature value and the second preset temperature value.

17. The method as described in claim 16, wherein the reference temperature value is null before the fan finishes accelerating or decelerating for a first time.

18. The method as described in claim 17, wherein the reference temperature value is set as null when the real-time temperature value of the electronic device is between the first preset temperature value and the second preset temperature value after the fan finishes accelerating or decelerating for the first time.
